(19) United States
(12) Patent Application Publication
(10) Pub. No.: US 2014/0037262 A1
(43) Pub. Date: Feb. 6, 2014

(54) DATA STORAGE DEVICE AND STORAGE MEDIUM

(71) Applicant: SONY CORPORATION, Tokyo (JP)

(72) Inventors: YOICHIRO SAKO, Tokyo (JP); YASUNORI KAMADA, Kanagawa (JP); KAZUNORI HAYASHI, Tokyo (JP); TAKAYASU KON, Tokyo (JP); KOHEI ASADA, Kanagawa (JP); KAZUYUKI SAKODA, Chiba (JP); AKIRA TANGE, Tokyo (JP); KAZUHIRO WATANABE, Tokyo (JP); KATSUHISA ARATANI, Kanagawa (JP); MITSURU TAKEHARA, Tokyo (JP); TAKATOSHI NAKAMURA, Kanagawa (JP); HIROYUKI HANAYA, Kanagawa (JP); YUKI KOGA, Tokyo (JP); TOMOYA ONUMA, Shizuoka (JP)

(73) Assignee: SONY CORPORATION, Tokyo (JP)

(21) Appl. No.: 13/948,428

(22) Filed: Jul. 23, 2013

(30) Foreign Application Priority Data
Aug. 2, 2012 (JP) 2012-172041

(51) Int. Cl. H04N 5/77

(52) U.S. Cl. CPC H04N 5/77
USPC 386/223

(57) ABSTRACT

There is provided a data storage device that conducts at least one of audio recording and video recording, the data storage device including a trigger signal transmitter that transmits a given trigger signal to an external device, a storage controller that applies control to conduct the at least one of audio recording and video recording, and a marking unit that marks stored data acquired by the at least one of audio recording and video recording at a time of transmitting the trigger signal.

### BACKGROUND

The present disclosure relates to a data storage device and a storage medium.

Typically, many people take photographs and video to save memories at amusement centers and tourist locations. Also, at large-scale amusement parks referred to as theme parks, cameras are installed at key locations in attractions. Such cameras automatically record images when the ride arrives, and these pictures are then sold as prints to desiring customers after the attraction ends. However, there has been dissatisfaction in that finishing prints takes time, and since there is an independent system for each attraction, collecting multiple photos together for a print has been unfeasible.

In order to resolve the above dissatisfaction, Japanese Unexamined Patent Application Publication No. 2001-177750, for example, discloses an image recording system that distributes communication means such as radio-frequency tags only to visitors who are to be recorded, and records images on the basis of detecting identification information transmitted from such communication means.

Also, Japanese Unexamined Patent Application Publication No. 2002-112074 discloses a system that records images on the basis of detecting a subject in a recording location according to an infrared or other sensor.

Meanwhile, another recent development is a wearable camera which is worn on a person's body and which automatically and continually records one's surroundings. Wearable cameras are also referred to as life logging cameras, since such cameras continually record one's daily life and activities.

Regarding such wearable cameras, Japanese Unexamined Patent Application Publication No. 2001-274936, for example, discloses technology that wirelessly connects information clients together to construct a personal wearable network that connects to the Internet.

In addition, Japanese Unexamined Patent Application Publication No. 2004-356970 discloses technology that switches between an ordinary recording mode, and an automatic recording mode that automatically records images while a camera is worn on one's body.

### SUMMARY

However, with a wearable camera (life logging camera), only one's surroundings are recorded, and images depicting oneself are not acquired.

Also, in the related art cited above, there is no particular discussion of linked operation between a wearable camera that records one's surroundings, and an automatic recording system that records oneself from nearby.

Accordingly, the present disclosure discloses a new and improved data storage device and storage medium enabling a device worn on one's body and devices disposed nearby to control video recording and/or audio recording at coordinated timings.

According to an embodiment of the present disclosure, there is provided a data storage device that conducts at least one of audio recording and video recording, the data storage device including a trigger signal transmitter that transmits a given trigger signal to an external device, a storage controller that applies control to conduct the at least one of audio recording and video recording, and a marking unit that marks stored data acquired by the at least one of audio recording and video recording at a time of transmitting the trigger signal.

According to an embodiment of the present disclosure, there is provided a storage medium having a program stored thereon, the program causing a computer to function as a trigger signal transmitter that transmits a given trigger signal to an external device, a storage controller that applies control to conduct at least one of audio recording and video recording, and a marking unit that marks stored data acquired by the at least one of audio recording and video recording at a time of transmitting the trigger signal.

According to the present disclosure as described above, a device worn on one's body and devices disposed nearby become able to control video recording and/or audio recording at coordinated timings.

### BRIEF DESCRIPTION OF THE DRAWINGS

FIG. 1 is a diagram summarizing a storage system according to an embodiment of the present disclosure;

FIG. 2 is a diagram illustrating an example of an overall configuration of a storage system according to the present embodiment;

FIG. 3 is a block diagram illustrating a configuration of a data storage device according to the present embodiment;

FIG. 4 is a block diagram illustrating a functional configuration of a CPU according to the present embodiment;

FIG. 5 is a diagram illustrating an example of stored data held in a storage medium according to the present embodiment;

FIG. 6 is a block diagram illustrating a configuration of external equipment according to the present embodiment;

FIG. 7 is a flowchart illustrating an operational process of a data storage device according to the present embodiment;

FIG. 8 is a diagram illustrating exemplary images that switch according to a perspective change operation performed by the user;

FIG. 9 is a diagram illustrating an example of a composite image according to the present embodiment;

FIG. 10 is a diagram illustrating an example of composition with a past image according to the present embodiment;

FIG. 11 is a diagram illustrating an overall configuration of a storage system according to a first exemplary modification of the present embodiment;

FIG. 12 is a flowchart illustrating an operational process of a data storage device according to the first exemplary modification;

FIG. 13 is a flowchart illustrating an operational process of a data storage device according to the first exemplary modification;

FIG. 14 is a flowchart illustrating an operational process of a data storage device according to the first exemplary modification;

FIG. 15 is a flowchart illustrating an operational process of external equipment according to the first exemplary modification;

FIG. 16 is a flowchart illustrating an operational process of external equipment according to the first exemplary modification;

FIG. 17 is a diagram illustrating a configuration of a storage system according to a second exemplary modification of the present embodiment;

FIG. 18 is a block diagram illustrating a functional configuration of a CPU in external equipment according to the second exemplary modification; and

FIG. 19 is a diagram illustrating a configuration of a storage system according to a third exemplary modification according to the present embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will proceed in the following order.

1. Summary of storage system according to an embodiment of the present disclosure

2. Basic configuration
2-1. System configuration
2-2. Data storage device
2-3. External equipment

3. Operational process

4. Image generation

5. Exemplary modifications
5-1. First exemplary modification
5-2. Second exemplary modification
5-3. Third exemplary modification

6. Conclusion

<1. Summary of Storage System According to an Embodiment of the Present Disclosure>

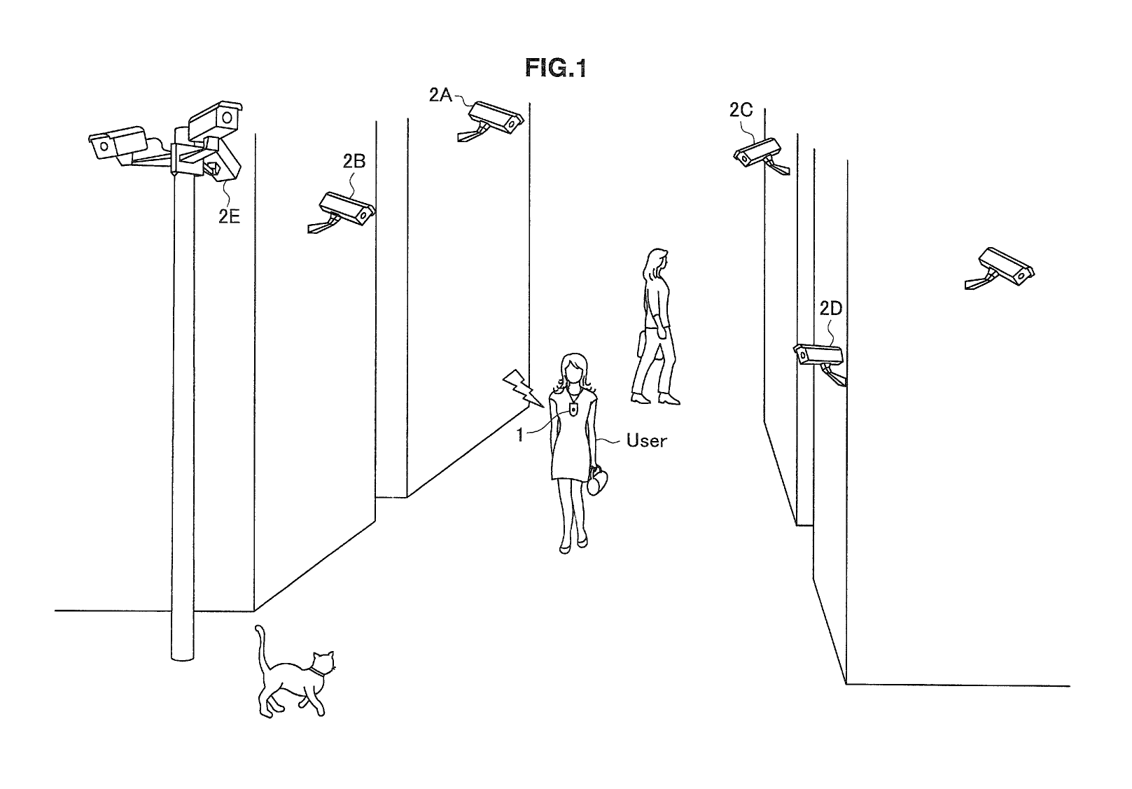

First, a storage system according to an embodiment of the present disclosure will be summarized with reference to FIG. 1. FIG. 1 is a diagram summarizing a storage system according to an embodiment of the present disclosure. The storage system according to the present embodiment assumes a situation in which a large number of various sensors such as cameras and microphones (hereinafter abbreviated to mic) are disposed not only outdoors as illustrated in FIG. 1, but also indoors.

In the example illustrated in FIG. 1, external equipment 2A to 2E is disposed throughout an outdoor area. The external equipment 2A to 2E each includes a camera and mic, and continually records video and audio.

Meanwhile, the user illustrated in FIG. 1 is wearing a data storage device 1 (wearable device) capable of automatically recording video and audio of the surroundings. The data storage device 1 is able to record video and audio while being worn on the user. In the example illustrated in FIG. 1, the data storage device 1 is worn such that a face provided with an imaging lens is in front. Note that the method of wearing the data storage device 1 is not limited to a method of being worn around the user's neck by a lanyard attached to the data storage device 1 as illustrated in FIG. 1. For example, the data storage device 1 may also be attached to the user's hat, clothing, shoes, or the like, and may also be inserted into a pocket of the user's clothing.

In this way, the user is able to automatically and continually record his or her surroundings with the data storage device 1 worn on his or her body, and acquire a life log. However, as discussed earlier, with an ordinary wearable camera (life logging camera), only one's surroundings are recorded, and images depicting the oneself are not acquired.

Herein, it is possible to acquire images depicting oneself from the external equipment 2A to 2E disposed around the user.

Thus, focusing on the above circumstances led to the creation of a storage system according to the embodiments of the present disclosure. In a storage system according to the embodiments of the present disclosure, a data storage device worn on the user and external equipment disposed around the user are able to control audio/video recording at approximately the same timings, and associate respective stored data acquired by audio/video recording. Thus, stored data in which the user's surroundings are audio/video recorded is associated with stored data obtained by conducting audio/video recording from nearby that includes the user himself at coordinated timings, and the user is able to acquire true life log data.

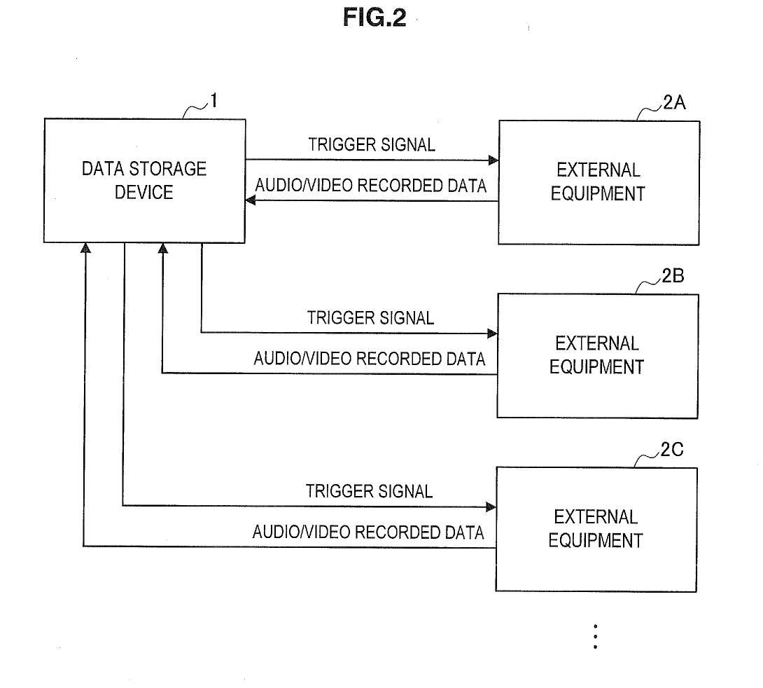

The above thus summarizes a storage system according to an embodiment of the present disclosure. Next, a configuration of a storage system according to the present embodiment will be described in detail with reference to FIGS. 2 to 6.

<2. Basic Configuration>

[2-1. System Configuration]

FIG. 2 is a diagram illustrating an example of an overall configuration of a storage system according to the present embodiment. As illustrated in FIG. 2, a storage system according to the present embodiment includes a data storage device 1 and external equipment 2.

The data storage device 1 transmits a trigger signal by short-range wireless communication such as Wi-Fi, Bluetooth (registered trademark), or infrared communication, for example. A trigger signal herein refers to a signal issuing given control instructions to the external equipment 2.

At the time of transmitting the trigger signal, the data storage device 1 also marks stored data obtained by conducting audio/video recording.

Meanwhile, upon receiving the trigger signal, external equipment 2A to 2C each apply control according to the trigger signal. For example, the external equipment 2A to 2C may transmit stored data obtained by conducting audio/video recording, at the time of receiving the trigger signal to the data storage device 1.

In so doing, the data storage device 1 according to the present embodiment is able to acquire stored data in which the user's surroundings are audio/video recorded, and stored data in which the user is audio/video recorded from nearby at coordinated timings from the external equipment 2. In addition, on the basis of markings applied to stored data obtained by conducting audio/video recording, the data storage device 1 is able to extract stored data in which the user is audio/video recorded from nearby at coordinated timings from the external equipment 2. Hereinafter, configurations of the data storage device 1 and the external equipment 2 according to the present embodiment will be respectively described.

[2-2. Data Storage Device]

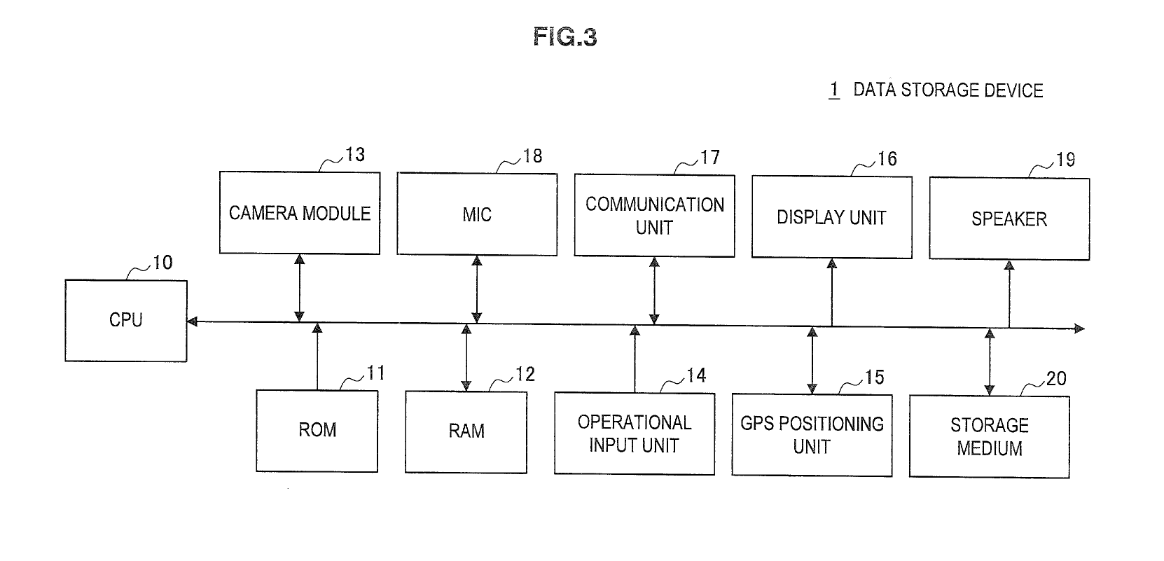

FIG. 3 is a block diagram illustrating a configuration of a data storage device 1 according to the present embodiment. As illustrated in FIG. 3, the data storage device 1 according to the present embodiment includes a CPU 10, ROM 11, RAM 12, a camera module 13, an operational input unit 14, a GPS positioning unit 15, a display unit 16, a communication unit 17, a mic 18, a speaker 19, and a storage medium 20. Hereinafter, the respective components will be specifically described.

The camera module 13 includes an image sensor, imaging optics that include an imaging lens, and a recorded image signal processor. The camera module outputs data of a recorded image in the form of a digital signal. Note that the image sensor is realized by a charge-coupled device (CCD) imager or a complementary metal-oxide-semiconductor (CMOS) imager, for example.

The operational input unit 14 accepts operational input from the user. The operational input unit 14 includes elements such as a power switch, an audio/video recording instruction unit, and a settings button, for example. The audio/video recording instruction unit is an element by which the user issues instructions for the camera module 13 to conduct a video recording process and the mic 18 to conduct an audio recording process, and may be realized in button format, such as a shutter button/audio record (rec) button, for example. Also, the audio/video recording instruction unit may be realized in a format whereby the user pulls a cord attached to the data storage device 1.

The GPS positioning unit 15 receives radio waves from GPS satellites, detects the position where the data storage device 1 exists, and outputs the detected position information. Note that the GPS positioning unit 15 is an example of a position information acquisition unit that detects the position of the data storage device 1 on the basis of an externally acquired signal, and the example of a position information acquisition unit according to the present embodiment is not limited thereto. For example, the position information acquisition unit may also detect position by Wi-Fi, by transmitting or receiving information with a mobile phone, PHS, or smartphone, or by short-range communication or the like.

The display unit 16 displays a real-time view of recorded images output from the camera module 13, and displays (plays) image data (still image data/motion image data) stored in the storage medium 20. In addition, the display unit 16 is realized with a liquid crystal display (LCD) or an organic light-emitting diode (OLED) display, for example.

The communication unit 17 is a communication interface for data communication with external devices. The communication unit 17 according to the present embodiment transmits a trigger signal to external equipment in response to control by the CPU 10, for example, and receives data obtained by conducting audio/video recording (recorded images, recorded audio data) in response to such a trigger signal from the external equipment 2.

The mic 18 picks up nearby sounds, converts the sounds into a digital signal via an amp and an analog-to-digital converter (ADC), and outputs audio data.

The speaker 19 converts audio data into an analog signal for output (playback) via a digital-to-analog converter (DAC) and an amp. The speaker 19 according to the present embodiment may also play back recorded audio data being held in the storage medium 20, for example.

The storage medium 20 is an image storage unit that holds various stored data obtained by conducting audio/video recording, and is realized with a recording medium such as a memory card or other flash memory, or a Digital Versatile Disc (DVD), for example. The storage medium 20 may also hold recorded images continually output from the camera module 13 as still image data (photos) according to the operational timings of a shutter button. The storage medium 20 may also hold recorded images continually output from the camera module 13 as motion image data (video).

The storage medium 20 may also hold audio data picked up by the mic 18 according to the operational timings of an audio record button.

In addition, the storage medium 20 may also hold recorded images and recorded audio data that the communication unit 17 receives from external equipment 2.

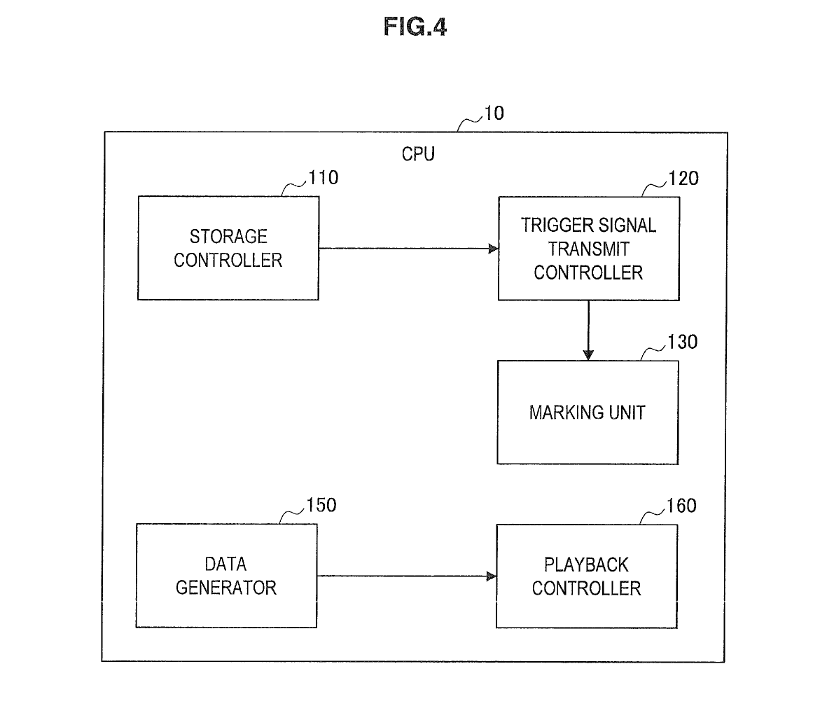

The CPU 10 is a controller that controls the respective components of the data storage device 1. Specific functions of the CPU 10 will be discussed later with reference to FIG. 4.

The ROM 11 stores information such as programs by which the CPU 10 performs respective processes. Meanwhile, the RAM 12 is used as a work area when the CPU 10 executes a program stored in the ROM 11.

(Specific Functions of CPU 10)

FIG. 4 is a block diagram illustrating a functional configuration of a CPU 10 according to the present embodiment. As illustrated in FIG. 4, the CPU 10 includes a storage controller 110, a trigger signal transmit controller 120, a marking unit 130, a data generator 150, and a playback controller 160.

The storage controller 110 controls the storage medium 20 to hold recorded images recorded by the camera module 13, and controls the storage medium 20 to hold audio data picked up (recorded) by the mic 18 as stored data. The CPU 10 may also continually control audio/video recording at preset periodic or non-periodic timings, or in the case where the user issues audio/video recording instructions at arbitrary timings via the operational input unit 14.

The trigger signal transmit controller 120 controls the communication unit 17 to transmit a trigger signal to external equipment 2 in response to audio/video recording by the storage controller 110. Specifically, the trigger signal transmit controller 120 broadcasts a trigger signal by short-range wireless communication to multiple external equipment 2A to 2E (see FIG. 1) installed nearby, for example. Also, as discussed earlier, the trigger signal is a signal issuing given control instructions to the external equipment 2. The trigger signal transmit controller 120 may also generate and transmit to the external equipment 2 a trigger signal instructing the external equipment 2 to transmit data obtained by conducting audio/video recording, at the time of receiving the trigger signal to the data storage device 1, for example.

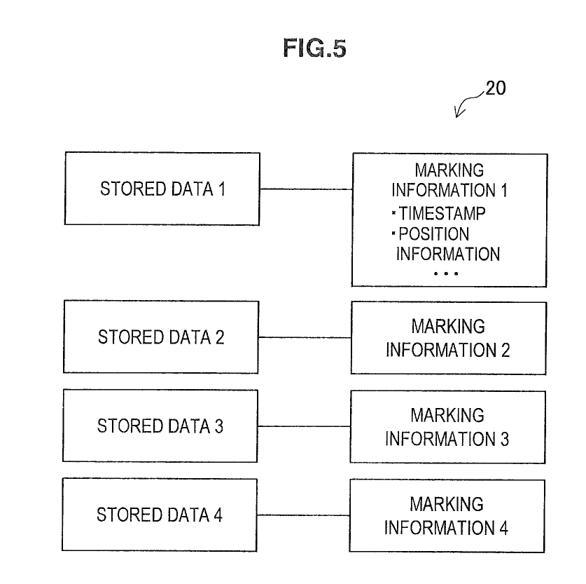

The marking unit 130 applies control to mark stored data obtained by conducting audio/video recording in the data storage device 1 and held in the storage medium 20 at the time of transmitting the trigger signal. Herein, FIG. 5 illustrates an example of stored data held in the storage medium 20. As illustrated in FIG. 5, the marking unit 130 attaches marking information to each instance of image data. The marking information may be a time stamp (time information) and position information detected by the GPS positioning unit 15, for example.

The data generator 150 generates given data on the basis of data in which the user's surroundings are audio/video recorded from the data storage device 1 (first stored data) and data in which the user is audio/video recorded from nearby at approximately the same timings from external equipment 2 (second stored data). For example, in the case where the markings attached to the first stored data are time stamps and position information, the data generator 150 extracts second stored data with approximately the same time stamps and position information, and generates given data.

The given data that the data generator 150 generates refers to a composite image made up of the first and second stored data in the case where the first and second stored data are recorded images, for example. Also, in the case where there is a first recorded image and multiple second recorded images, the data generator 150 may generate images that switch according to a perspective change operation by the user, on the basis of the position information attached to each recorded image. Note that images generated by the data generator 150 according to the present embodiment will be described in detail below in Section 4: Image generation.

The playback controller 160 applies control to play back data generated by the data generator 150. Specifically, in the case where the data generator 150 generates a composite image, for example, the playback controller 160 applies control to display the composite image on the display unit 16. Also, in the case where the data generator 150 generates images that switch according to a perspective change operation, the playback controller 160 may also apply control to successively switch the recorded image to display on the display unit 16 according to a telescopic/wide-angle operation by the user.

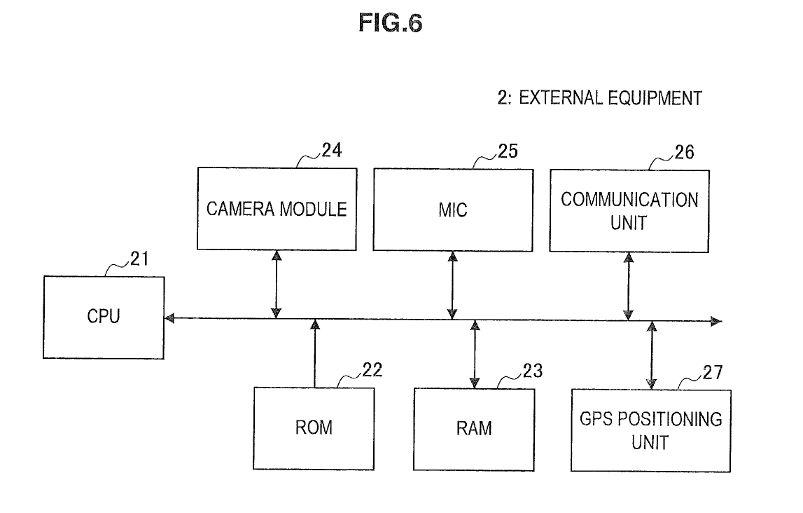

The above thus describes in detail a configuration of the data storage device 1 according to the present embodiment. Next, a configuration of external equipment 2 according to the present embodiment will be described with reference to FIG. 6.

[2-3. External Equipment]

FIG. 6 is a block diagram illustrating a configuration of external equipment 2 according to the present embodiment. As illustrated in FIG. 6, the external equipment 2 includes a CPU 21, ROM 22, RAM 23, a camera module 24, a mic 25, a communication unit 26, and a GPS positioning unit 27. Since the main functions of the camera module 24, the mic 25, the GPS positioning unit 27, the ROM 22, and the RAM 23 are similar to the corresponding components of the data storage device 1, further description will be reduced or omitted.

The communication unit 26 is a communication interface for data communication with external devices. The communication unit 26 according to the present embodiment receives a trigger signal from the data storage device 1 in response to control by the CPU 21, for example, and transmits audio/video data recorded by the external equipment 2 in response to the trigger signal (recorded images, recorded audio data) to the data storage device 1.

The CPU 21 is a controller that controls the respective components of the external equipment 2. For example, the CPU 21 applies given control instructed by a trigger signal that the communication unit 26 receives from the data storage device 1. Specifically, in response to the trigger signal, the CPU 21 applies control to transmit recorded images recorded by the camera module 24 and audio data picked up (recorded) by the mic 25 to the data storage device 1, for example. The CPU 21 may also attach position information about the external equipment 2 detected by the GPS positioning unit 27 and time information indicating the audio/video recording times (time stamps) to the recorded images and audio data, and transmit the results.

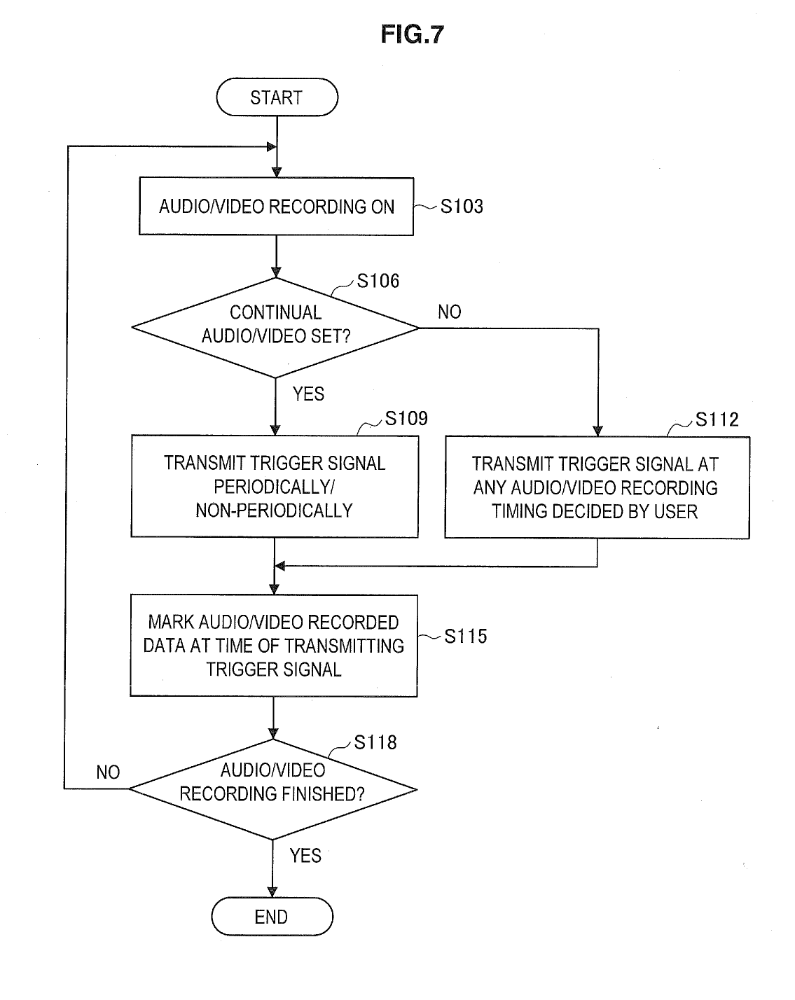

The above thus describes in detail the components of a storage system according to an embodiment of the present disclosure. Next, an operational process of the data storage device 1 according to the present embodiment will be described in detail with reference to FIG. 7.

<3. Operational Process>

FIG. 7 is a flowchart illustrating an operational process of a data storage device 1 according to the present embodiment. As illustrated in FIG. 7, first, in step S103 an ON operation for audio/video recording by the data storage device 1 (a power switch ON operation) is performed.

Next, in step S106, the CPU 10 determines whether or not the data storage device 1 is set to continually record audio/video. Herein, the data storage device 1 according to the present embodiment is worn by the user and acquires a life log by continually recording the user's surroundings, but it is also possible to use a setting to switch between continual audio/video recording and audio/video recording at the user's arbitrary timings. The storage controller 110 controls audio/video recording according to the setting. Such a switch setting may also be conducted in advance according to a user operation detected by the operational input unit 14. Also, in the case where the instruction unit that instructs audio/video recording is a touch sensor and audio/video recording is conducted in response to user touch, the CPU 10 may determine continual audio/video recording in the case where the touch duration is longer than a given duration, and determine one-off audio/video recording in the case where the touch duration is shorter, for example.

Next, in the case where the storage controller 110 is set to continually record audio/video (S106; Yes), in step S109 the trigger signal transmit controller 120 applies control to periodically/non-periodically transmit a trigger signal to external equipment 2. For example, the storage controller 110 may be controlled to continually record audio/video for a given duration, and in the case of acquiring video data for a life log, the trigger signal transmit controller 120 may transmit a trigger signal at given intervals (every 30 minutes, for example).

On the other hand, in the case where the storage controller 110 is not set to continually record audio/video (S 106; No), in step S109 the trigger signal transmit controller 120 applies control to transmit a trigger signal to external equipment 2 at arbitrary audio/video recording timings by the user. Specifically, the trigger signal transmit controller 120 applies control to transmit a trigger signal to external equipment 2 when a shutter button/audio record button is operated, for example.

Subsequently, in step S115 the marking unit 130 marks the data obtained by conducting audio/video recording at the time of transmitting the trigger signal. For example, in the case where the storage controller 110 continually records audio/video for a given amount of time, frames in the acquired video data that correspond to the time of transmitting the trigger signal (every 30 minutes, for example) may be marked.

Next, in step S118, if an audio/video recording stop operation (power switch OFF operation) is performed, the CPU 10 ends the operational process.

The above thus describes in detail a marking process of the data storage device 1 according to the present embodiment. As discussed above, by attaching markings to audio/video data recorded by the data storage device 1 at the time of transmitting a trigger signal to external equipment 2, it is possible to later associate audio/video data recorded by the external equipment 2 on the basis of the markings.

<4. Image Generation>

Next, an example of given data generated by the data generator 150 on the basis of respective instances of stored data associated on the basis of markings will be described. The description below uses recorded images as an example of stored data.

### First Image Generation Example

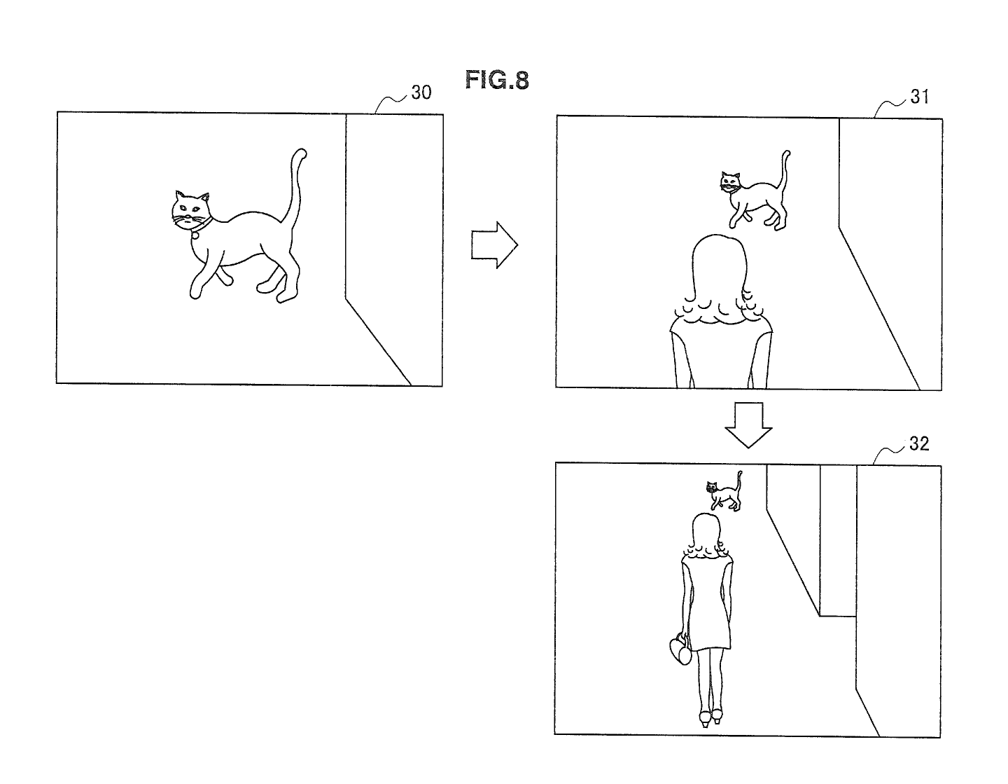

For example, the data generator 150 is able to generate images that switch according to a perspective change operation by the user, on the basis of position information attached to recorded images. The description hereinafter will refer to FIG. 8.

FIG. 8 is a diagram illustrating exemplary images that switch according to a perspective change operation performed by the user. As illustrated in FIG. 8, first, a recorded image 30 recorded by the data storage device 1 is displayed, for example. Next, if the user performs a wide-angle operation, a recorded image 31 recorded by external equipment 2 disposed behind the user (that is, an image depicting the user from behind) is displayed. In addition, if the user once again performs a wide-angle operation, a recorded image 32 recorded by external equipment 2 disposed farther behind is displayed.

Thus, since the user is able to view recorded images of the user recorded from nearby in addition to recorded images from the user's own point of view recorded by the data storage device 1, the user is able to acquire a true life log.

### Second Image Generation Example

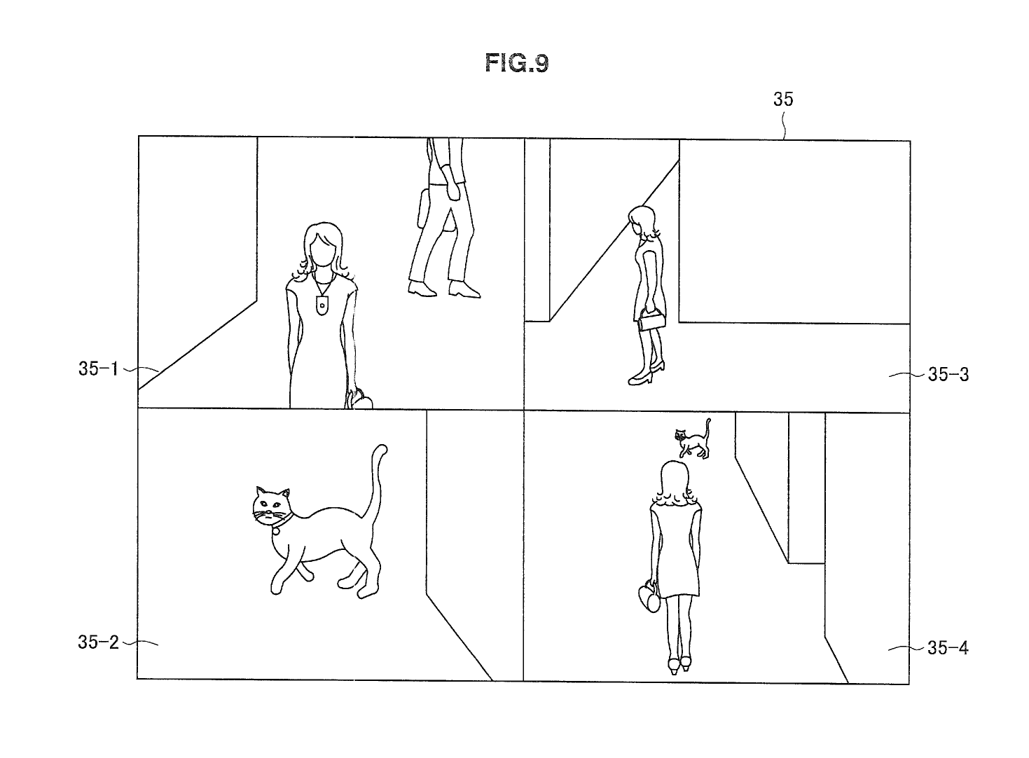

Additionally, the data generator 150 is also able to generate a composite image compositing recorded images recorded by the data storage device 1 with recorded images recorded by external equipment 2. The description hereinafter will refer to FIG. 9.

FIG. 9 is a diagram illustrating an example of a composite image compositing recorded images recorded by the data storage device 1 with recorded images recorded by external equipment 2. As illustrated in FIG. 9, the data generator 150 generates a composite image 35 that includes recorded images 35-1, 35-3, and 35-4 recorded by external equipment 2, and a recorded image 35-2 recorded by the data storage device 1.

Thus, since the user is able to view recorded images of the user recorded from nearby in addition to recorded images from the user's own point of view recorded by the data storage device 1, the user is able to acquire a true life log.

### Third Image Generation Example

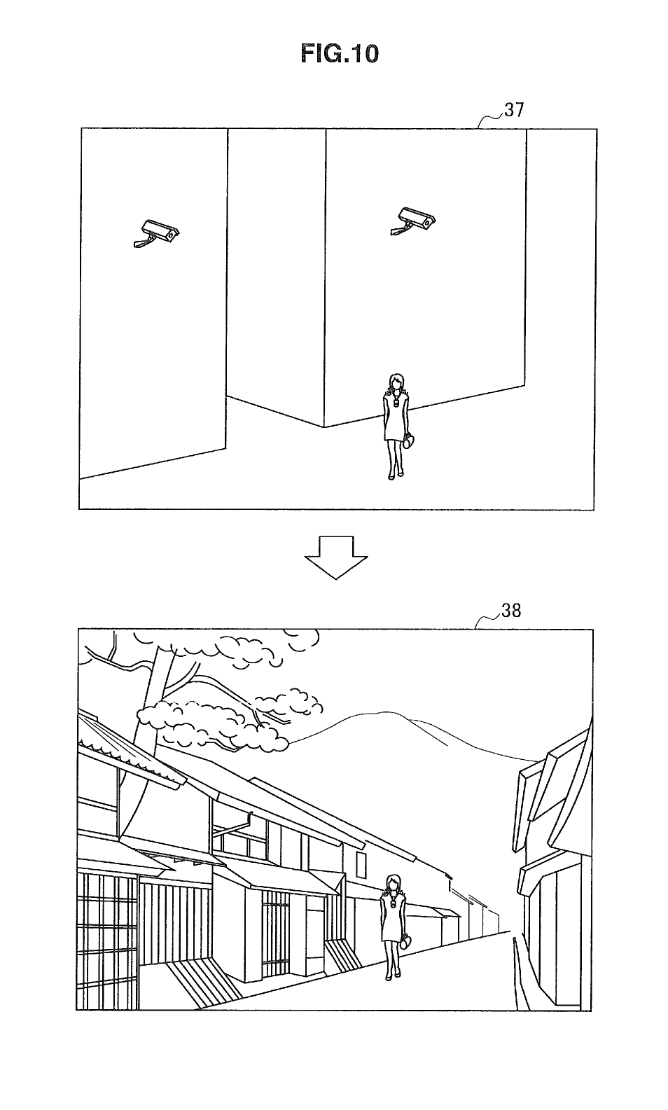

Additionally, the data generator 150 is also able to generate a composite image compositing a recorded image recorded by the data storage device 1 or a recorded image recorded by external equipment 2 with a past image. The description hereinafter will refer to FIG. 10.

FIG. 10 is a diagram illustrating an example of an image generated by compositing a recorded image recorded by external equipment 2 with a past image. As illustrated in FIG. 10, the data generator 150 generates an image 38 compositing a past image into the user's background on the basis of a recorded image 37 recorded by external equipment 2. Herein, a past image may refer to an image depicting a past landscape of the place depicted in the recorded image 37. The data generator 150 may also select a past image on the basis of position information attached to the recorded image 37. The data generator 150 may also analyze the recorded image 37 and composite the past image to match extracted features.

<5. Modifications>

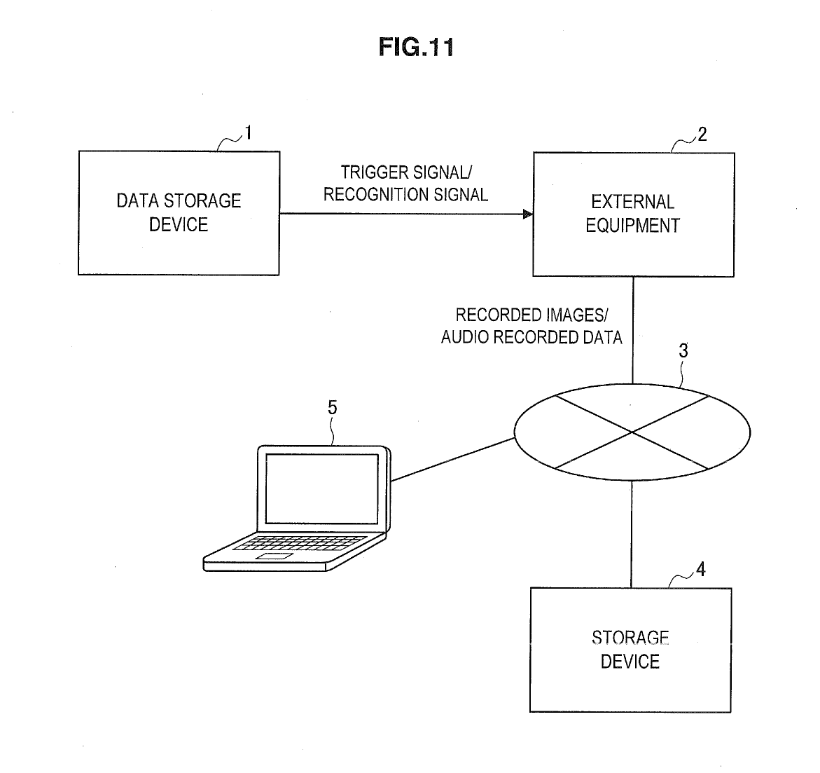

Although the foregoing describes a storage system according to the present embodiment, a storage system according to the present embodiment is not limited to the configuration illustrated in FIG. 2. Hereinafter, a storage system according to a first exemplary modification of the present embodiment will be described with reference to FIGS. 11 to 16.

[5-1. First Exemplary Modification]

FIG. 11 is a diagram illustrating an overall configuration of a storage system according to a first exemplary modification of the present embodiment. As illustrated in FIG. 11, external equipment 2 according to the present exemplary modification is connected to a network 3. A storage device 4 and an information processing device 5 are also connected to the network 3.

The external equipment 2 according to the present exemplary modification receives a trigger signal and an identification signal from the data storage device 1. In addition, the external equipment 2 conducts marking (or bookmarking) by attaching an identification signal to data obtained by conducting audio/video recording in response to the trigger signal. The external equipment 2 then transmits the marked data obtained by conducting audio/video recording to the storage device 4. The identification signal may be a user ID or an ID of the data storage device 1.

In so doing, the user is able to later acquire recorded images marked by his or her user ID from the storage device 4 with the information processing device 5, for example. Additionally, the information processing device 5 according to the present exemplary modification may also acquire audio/video data recorded by the data storage device 1, and function as the data generator 150 and the playback controller 160 illustrated in FIG. 4.

Hereinafter, an operational process of the data storage device 1 and an operational process of external equipment 2 according to the present exemplary modification will be successively described. Note that in the present exemplary modification, it is possible to selectively switch between audio/video recording with either the data storage device 1 or the external equipment 2.

(Operational Process of Data Storage Device 1 According to First Exemplary Modification)

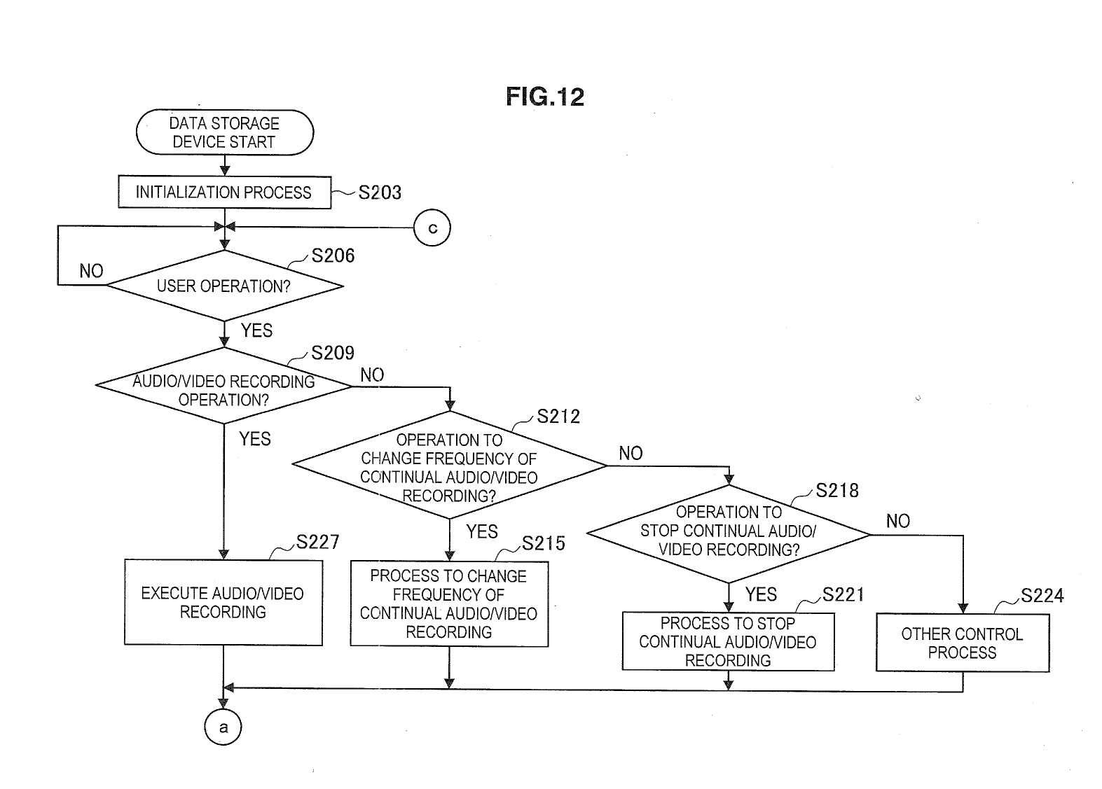

FIGS. 12 to 14 are flowcharts illustrating an operational process of a data storage device 1 according to the first exemplary modification.

First, in step S203 of FIG. 12, the data storage device 1 conducts an initialization process.

Next, in step S206, the CPU 10 of the data storage device 1 determines whether or not the operational input unit 14 has detected a user operation.

Next, if a user operation is detected (S206; Yes), in step S209 the CPU 10 determines whether or not the detected user operation is an audio/video recording operation.

Subsequently, if the detected user operation is not an audio/video recording operation (S209; No), in step S212 the CPU 10 determines whether or not the detected user operation is an operation for changing the frequency of continual audio/video recording.

Next, if the detected user operation is an operation for changing the frequency of continual audio/video recording (S212; Yes), in step S215 the CPU 10 conducts a process that changes the frequency of continual audio/video recording.

Subsequently, if the detected user operation is not an operation for changing the frequency of continual audio/video recording (S212; No), in step S218 the CPU 10 determines whether or not the detected user operation is an operation for stopping continual audio/video recording.

Next, if the detected user operation is an operation for stopping continual audio/video recording (S218; Yes), in step S221 the CPU 10 stops continual audio/video recording.

Subsequently, if the detected user operation not an operation for stopping continual audio/video recording (S218; No), in step S224 the CPU 10 conducts another control process according to user operation.

Next, in the case where the detected user operation is an audio/video recording operation (S209; Yes), in step S227 the storage controller 110 of the CPU 10 controls the camera module 13/mic 18 to execute audio/video recording.

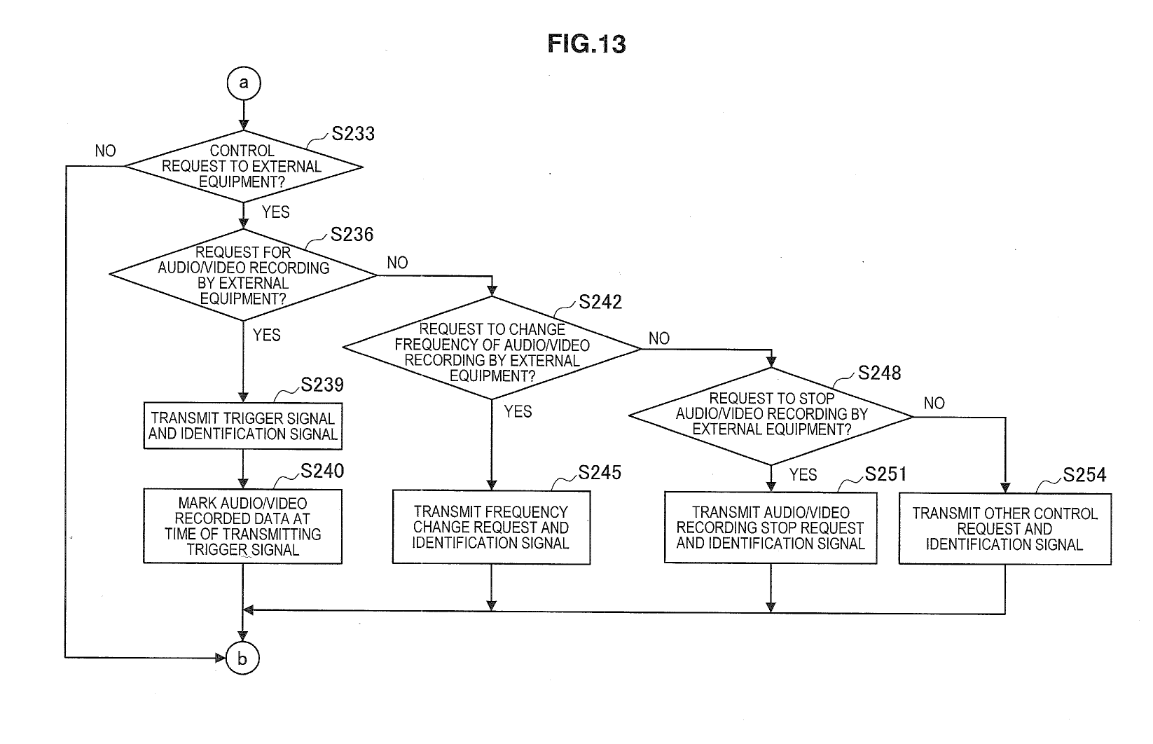

Subsequently, in step S233 illustrated in FIG. 13, the CPU 10 of the data storage device 1 determines whether or not to issues a control request to the external equipment 2. For example, the CPU 10 may make a determination according to whether or not a setting for issuing a control request to the external equipment 2 is set.

Next, in the case of determining to issue a control request to the external equipment 2 (step S233; Yes), in step S233 the CPU 10 determines whether the control request to the external equipment 2 is to be an audio/video recording request. For example, the data storage device 1 according to the present exemplary modification is set to transmit a trigger signal instructing audio/video recording to the external equipment 2 when the data storage device 1 records audio/video or at an arbitrary user timing (such as when an instruction unit is operated). In this case, the CPU 10 determines that the control request is to be an audio/video recording request when the data storage device 1 has recorded audio/video or at an arbitrary user timing (such as when an instruction unit is operated).

Subsequently, in the case where the control request is an audio/video recording request (S236; Yes), in step S239 the trigger signal transmit controller 120 applies control to transmit a trigger signal and an identification signal to the external equipment 2.

Subsequently, in step S240 the marking unit 130 marks audio/video data recorded in the data storage device 1 at the time of transmitting the trigger signal.

Next, in the case where the control request is not an audio/video recording request (S236; No), in step S242 the CPU 10 determines whether or not the control request is a request for changing the frequency of audio/video recording by the external equipment 2. The frequency of audio/video recording refers to how frequently the external equipment 2 records audio/video, and in the case where the external equipment 2 is set to take multiple audio/video recordings at a given frequency upon receiving a trigger signal, for example, the data storage device 1 is able to request a change in this frequency according to a user operation.

Subsequently, in the case where the control request is a request for changing the frequency of audio/video recording (S242; Yes), in step S245 the CPU 10 controls the communication unit 17 to transmit a frequency change request and an identification signal to the external equipment 2.

Next, in the case where the control request is not a request for changing the frequency of audio/video recording (S242; No), in step S248 the CPU 10 determines whether or not the control request is a request for stopping audio/video recording by the external equipment 2.

Subsequently, in the case where the control request is a request for stopping audio/video recording by the external equipment 2 (S248; Yes), in step S251 the CPU 10 controls the communication unit 17 to transmit an audio/video recording stop request and an identification signal to the external equipment 2.

Next, in the case where the control request is not a request for stopping audio/video recording by the external equipment 2 (S248; No), in step S254 the CPU 10 controls the communication unit 17 to transmit a given control request set in some other way, as well an identification signal, to the external equipment 2.

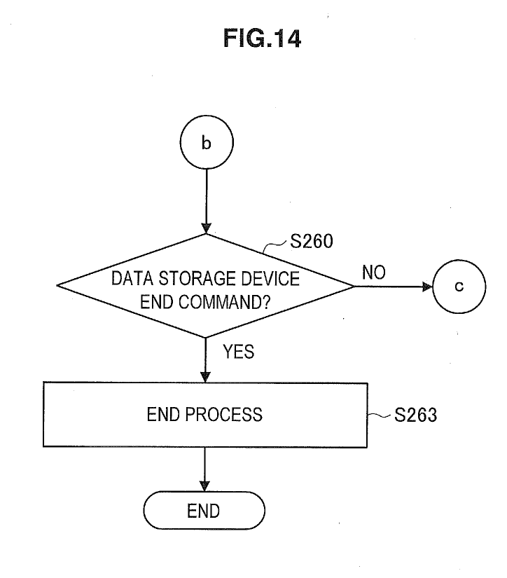

Subsequently, in the case of detecting a command to end the process of the data storage device 1 (such as a power switch OFF operation) in step S260 illustrated in FIG. 14, the CPU 10 conducts an end process in step S63.

The above thus describes in detail an operational process of the data storage device 1 according to the present exemplary modification. Next, an operational process of the external equipment 2 according to the present exemplary modification will be described.

(Operational Process of External Equipment 2 According to First Exemplary Modification)

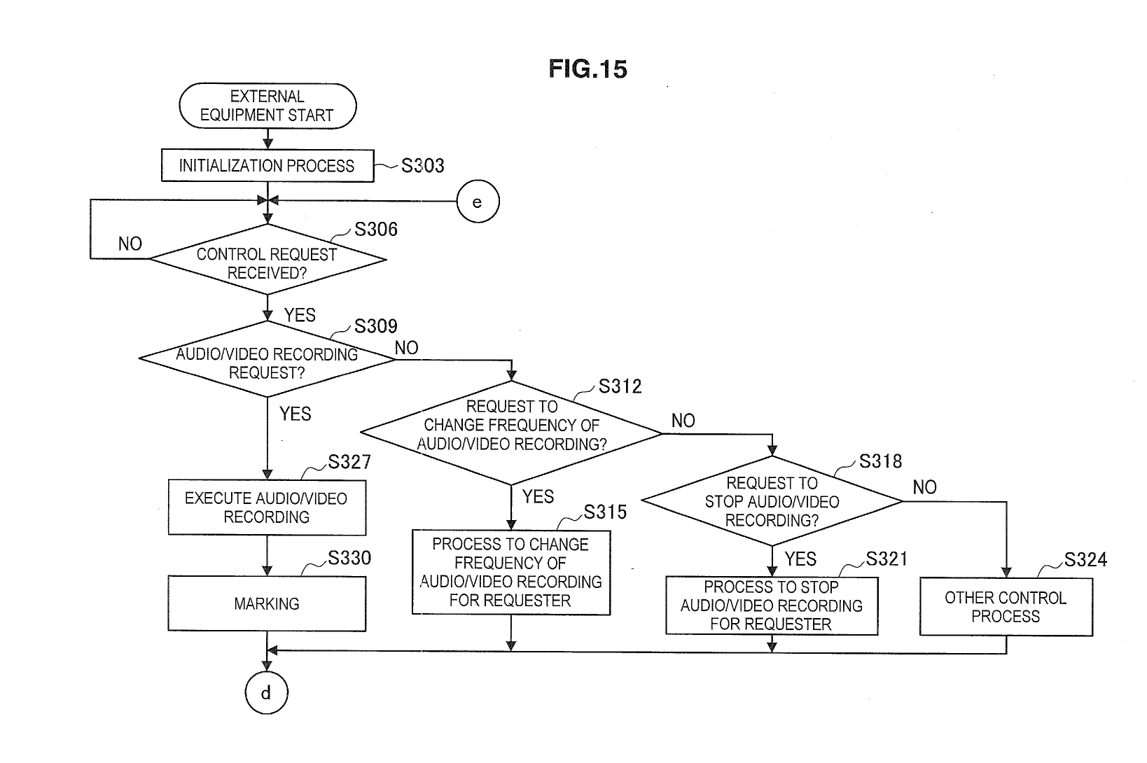

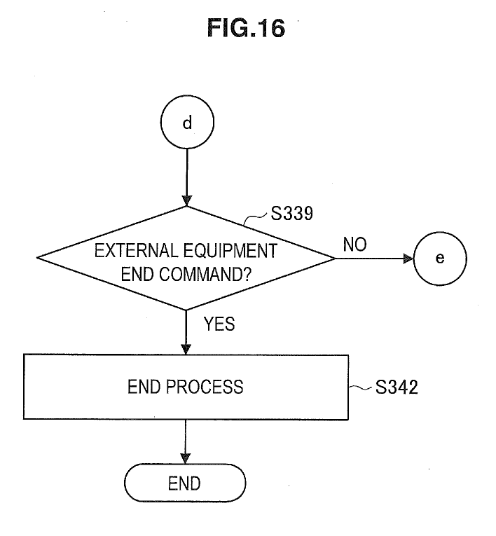

FIGS. 15 and 16 are flowcharts illustrating an operational process of the external equipment 2 according to the first exemplary modification.

First, in step S303 of FIG. 15, the external equipment 2 conducts an initialization process.

Subsequently, in step S306, the CPU 21 of the external instrument 2 determines whether or not the communication unit 26 has received a control request from the data storage device 1.

Next, in the case of receiving a control request (step S306; Yes), in step S309 the CPU 21 determines whether the received control request is requesting audio/video recording (a trigger signal).

Subsequently, if the received control request is not an audio/video recording request (S309; No), in step S312 the CPU 21 determines whether or not the received control request is a request for changing the frequency of audio/video recording.

Next, if the received control request is a request for changing the frequency of audio/video recording (S312; Yes), in step S315 the CPU 21 conducts a process that changes the frequency of audio/video recording for the requester. For example, in the case where the external equipment 2 is set to take multiple audio/video recordings at a given frequency upon receiving a trigger signal as discussed earlier, the CPU 21 changes this frequency according to the request from the data storage device 1.

Subsequently, if the received control request is not a request for changing the frequency of audio/video recording (S312; No), in step S318 the CPU 21 determines whether or not the control request is a request for stopping audio/video recording.

Next, if the received control request is a request for stopping audio/video recording (S318; Yes), in step S321 the CPU 21 stops audio/video recording. For example, in the case where the external equipment 2 continually records audio/video at a given frequency upon receiving a trigger signal, the CPU 21 stops this audio/video recording according to the request from the data storage device 1. More specifically, in the case where the external equipment 2 is multiply installed at an event locale such as a wedding hall or concert theater, the external equipment 2 is presumably set to continually record audio/video at a given frequency upon receiving a trigger signal from a data storage device 1 worn by a user.

Subsequently, if the received control request is not a request for stopping audio/video recording (S318; No), in step S324 the CPU 21 conducts some other kind of requested control process.

Next, in the case where the received control request is an audio/video recording request (S309; Yes), in step S327 the CPU 21 controls the camera module 24/mic 25 to execute audio/video recording.

Subsequently, in step S330, the CPU 21 marks the audio/video data recorded by the camera module 24/mic 25 by attaching the identification signal received from the data storage device 1.

Note that also envisioned are cases in which the external equipment 2 continually acquires audio/video data recorded by the camera module 24 and the mic 25, as with surveillance cameras/mics. In this case, in the above S330 the CPU 21 marks (or bookmarks) corresponding frames in the continually acquired video data at the time of receiving a trigger signal, or at a given frequency upon receiving a trigger signal.

Subsequently, in the case of detecting a command to end the process of the external equipment 2 in step S339 illustrated in FIG. 16, the CPU 21 conducts an end process in step S342.

The above thus describes an operational process of the external instrument 2 according to the present exemplary modification.

[5-2. Second Exemplary Modification]

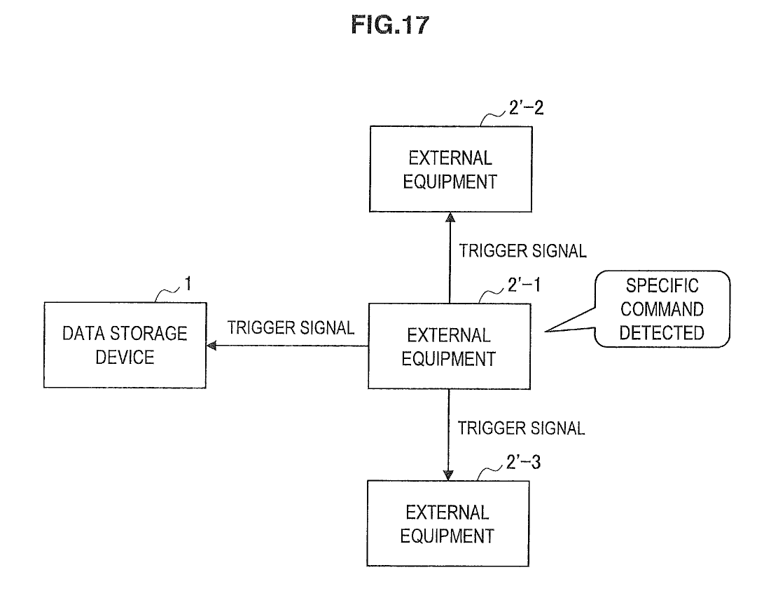

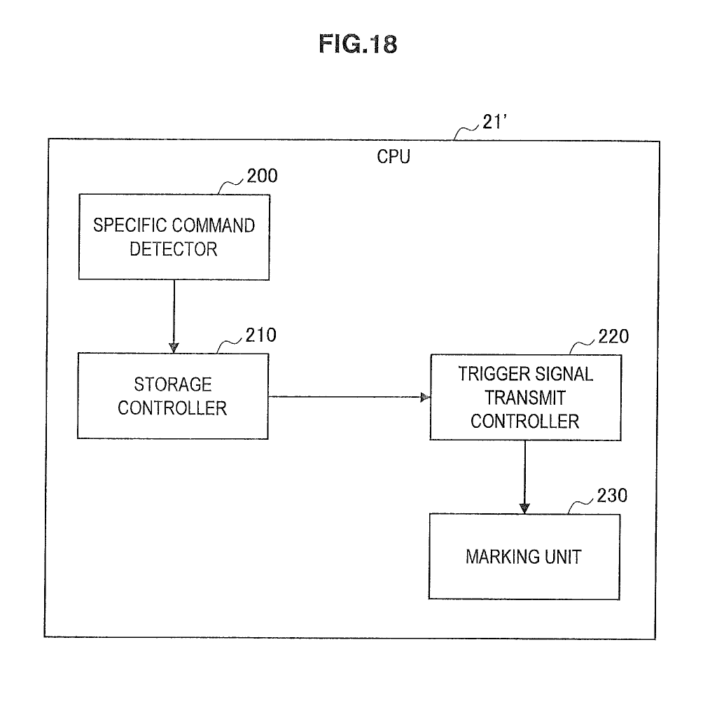

In the foregoing embodiment and first exemplary modification, a trigger signal is transmitted to one or more external equipment 2, which are external devices to the data storage device 1. However, a storage system according to the present embodiment is not limited thereto. For example, the process of the data storage device 1 may also be conducted on the external equipment 2 side. In this case, since the other external equipment and the data storage device 1 are external devices to the external equipment 2 according to the present embodiment (data storage device), a storage system according to the present disclosure also encompasses the case where the external equipment 2 transmits a trigger signal to these external devices and instructs the external devices to record audio/video. Hereinafter, such a case will be specifically described with reference to FIGS. 17 and 18.

(System Configuration)

FIG. 17 is a diagram illustrating a configuration of a storage system according to a second exemplary modification of the present embodiment. As illustrated in FIG. 17, the storage system according to the present exemplary modification includes a data storage device 1 and multiple external equipment 2′ (external equipment 2′-1, 2′-2, and 2′-3). The external equipment 2′ according to the present exemplary modification conducts audio/video recording control upon detecting a specific command on the basis of audio/video recorded data, and additionally broadcasts a trigger signal to external devices by short-range wireless communication or the like. Herein, external devices from the point of view of the external equipment 2′-1, for example, are the other external equipment 2′-2 and 2′-3 as well as the data storage device 1 positioned nearby.

The external equipment 2′-1 may also mark and hold audio/video data recorded at the time of transmitting a trigger signal, and may additionally transmit such data to a storage device 4 via a network 3 as illustrated in FIG. 11.

In addition, the other external equipment 2′-2 and 2′-3 as well as the data storage device 1 also conduct audio/video recording control upon receiving a trigger signal from the external equipment 2′-1. The other external equipment 2′-2 and 2′-3 as well as the data storage device 1 may reply to the external equipment 2′ with audio/video recorded data, and may also mark and hold audio/video recorded data. In addition, after marking audio/video recorded data, the other external equipment 2′-2 and 2′-3 as well as the data storage device 1 may also transmit such data to a storage device 4 via a network 3 as illustrated in FIG. 11. Furthermore, the marking by the other external equipment 2′-2 and 2′-3 as well as the data storage device 1 may involve attaching information such as time information, position information, and an ID of the external equipment 2′.

In so doing, it is possible to record audio/video with external equipment 2′-1, 2′-2, and 2′-3 positioned near a user, as well as with a data storage device 1 worn by the user him- or herself, at approximately the same timings. Also, by marking audio/video recorded data, it is possible to associate multiple instances of stored audio/video data recorded by multiple devices at approximately the same timings.

Herein, the specific command that the external equipment 2′ detects may be a gesture such as a smile, a wave of the hand, or a bend of the fingers, and may also be speech instructing audio/video recording, such as “Cheese!” or “Action!”, for example. The external equipment 2′ may also detect cheers or applause. Thus, when multiple external equipment 2′ are installed at a facility such as a wedding hall, concert theater, or theme park, for example, a user is able to acquire a life log in accordance with smiles and laughter or excitement.

Alternatively, the external equipment 2′ may also detect, on the basis of audio/video recorded data, situations such as an accident, an earthquake, an earthquake early-warning alarm, or screams as the specific command. Thus, it is possible for multiple devices to record audio/video of an emergency when an incident or accident occurs.

(Configuration of External Equipment)

The basic configuration of the external equipment 2′ according to the present exemplary modification includes a CPU 21′, the configuration of the external equipment 2 illustrated in FIG. 6 other than the CPU 21 (the ROM 22, RAM 23, camera module 24, mic 25, communication unit 26, and GPS positioning unit 27), and a storage unit.

The CPU 21′ is a controller that controls the respective components of the external equipment 2′. Specific functions of the CPU 21′ will be discussed below with reference to FIG. 18.

FIG. 18 is a block diagram illustrating a functional configuration of the CPU 21′ in the external equipment 2′ according to the second exemplary modification. As illustrated in FIG. 18, the CPU 21′ functions as a specific command detector 200, a storage controller 210, a trigger signal transmit controller 220, and a marking unit 230.

The specific command detector 200 detects a specific command on the basis of recorded images continually acquired by the camera module 24, or audio recorded data continually acquired by the mic 25. As discussed earlier, the specific command may be a gesture such as a smile, a wave of the hand, or a bend of the fingers, or information such as speech, cheers, applause, an accident, an earthquake, an earthquake early-warning alarm, or screams that instruct audio/video recording. The specific command detector 200 is able to detect a given specific command by pattern matching, for example.

The specific command detector 200 then informs the storage controller 210 that a specific command has been detected. Note that the specific command detector 200 may also generate additional information for audio/video recording control on the basis of the above audio/video recorded data, and issue such additional information to the storage controller 210. The additional information is information indicating the direction in which to record audio/video, for example. The specific command detector 200 may also compute the direction in which to record audio/video from an estimation of the sound source position of the specific command, image analysis, the gaze of a crowd depicted in an image, or the like.

The storage controller 210 controls audio/video recording upon being informed by the specific command detector 200 that a specific command was detected. Specifically, the storage controller 210 controls the storage unit (not illustrated) to hold recorded images acquired by the camera module 24 and audio recorded data acquired by the mic 25 as stored data. Also, in the case where the specific command detector 200 outputs information indicating the direction in which to record audio/video, the storage controller 210 controls the imaging direction of the camera module 24 and the directionality of the mic 25 accordingly.

The trigger signal transmit controller 220 controls the communication unit 26 to transmit a trigger signal to an external device in response to audio/video recording by the storage controller 210. Specifically, the trigger signal transmit controller 220 broadcasts a trigger signal by short-range wireless communication to the other external equipment 2′-2 and 2′-3 installed nearby, as well as to the data storage device 1, for example.

The marking unit 230 applies control to mark stored audio/video data recorded by the external equipment 2′ and held in the storage unit at the time of transmitting the trigger signal. The marking by the marking unit 230 may involve attaching a time stamp (time information) and position information detected by the GPS positioning unit 27, for example.

As described above, in a storage system according to the second exemplary modification, external equipment 2′ transmits a trigger signal. Thus, it is possible for a user to acquire audio/video life log data recorded by a data storage device 1 and multiple external equipment 2′, even without operating the data storage device 1 that the user is wearing, for example.

[5-3. Third Exemplary Modification]

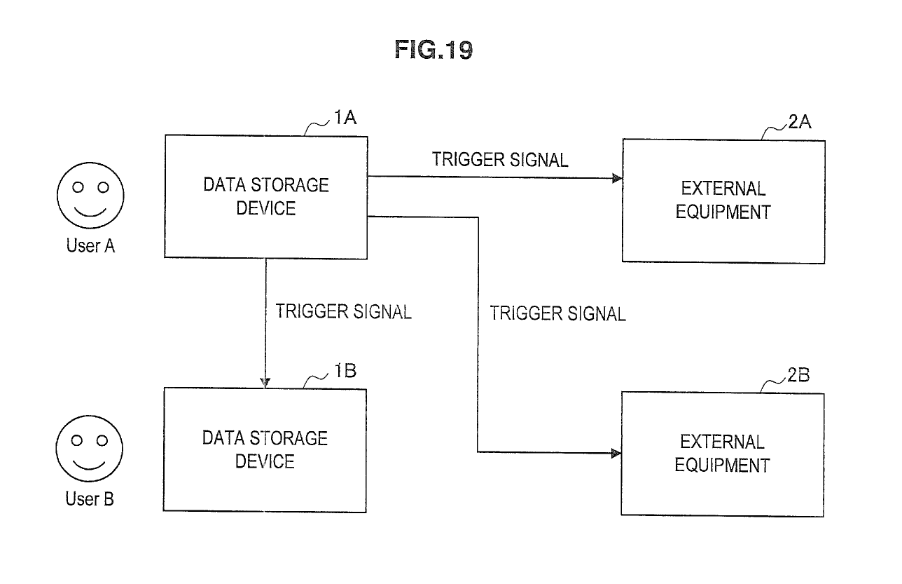

In the foregoing system configuration illustrated in FIG. 2, a data storage device 1 broadcasts a trigger signal to external equipment 2A to 2C disposed nearby. However, a storage system according to the present embodiment is not limited thereto. For example, in a storage system according to a third exemplary modification according to the present embodiment, the broadcast recipients of a trigger signal from the data storage device 1 may also include other data storage devices being worn by other users. Hereinafter, such a case will be specifically described with reference to FIG. 19.

FIG. 19 is a diagram illustrating a configuration of a storage system according to a third exemplary modification according to the present embodiment. As illustrated in FIG. 19, besides the external equipment 2A and 2B disposed nearby, a data storage device 1B being worn by a nearby user B may also be said to be an external device to a data storage device 1A being worn by a user A. Thus, the data storage device 1A according to the present exemplary modification may also broadcast a trigger signal by short-range wireless communication to the external equipment 2A and 2B as well as to the nearby data storage device 1B.

The data storage device 1A may also mark and hold audio/video data recorded at the time of transmitting a trigger signal, and may additionally transmit such data to a storage device 4 via a network 3 as illustrated in FIG. 11.

In addition, the other data storage device 1B and the external equipment 2A and 2B also conduct audio/video recording control upon receiving a trigger signal from the data storage device 1A. The data storage device 1B and the external equipment 2A and 2B may reply to the data storage device 1A with audio/video recorded data, and may also mark and hold audio/video recorded data. In addition, after marking audio/video recorded data, the data storage device 1B and the external equipment 2A and 2B may also transmit such data to a storage device 4 via a network 3 as illustrated in FIG. 11.

Thus, in a storage system according to the present exemplary modification, it is possible to acquire, as a life log, audio/video data recorded by not only external equipment 2A and 2b installed nearby, but also a data storage device 1B worn by a nearby user B.

Note that although the data storage device 1B is being worn by another user B in the example illustrated in FIG. 19, there are also envisioned cases in which the data storage device 1B is worn by something else, such as a stray cat, wild bird, or zoo animal. In this case, the user is able to acquire, as a life log, recorded images and recorded audio from the point of view of nearby animals.

Also, equipment such as the external equipment 2A and 2B may not only be installed on the walls of buildings and on utility poles as illustrated in FIG. 1, but may also be installed onto moving objects such as helicopters and automobiles. Thus, a user is able to acquire, as a life log, aerial images depicting the user from above and recorded from a helicopter flying overhead, for example.

<6. Conclusion>

As described in the foregoing, in a storage system according to the present embodiment, a data storage device worn on the user and external equipment disposed around the user are able to control audio/video recording at approximately the same timings, and associate respective stored data acquired by audio/video recording. Thus, stored audio/video data in which the user's surroundings are recorded is associated with stored audio/video data recorded from nearby that includes the user himself or herself at coordinated timings, and the user is able to acquire true life log data.

It should be understood by those skilled in the art that various modifications, combinations, sub-combinations and alterations may occur depending on design requirements and other factors insofar as they are within the scope of the appended claims or the equivalents thereof.

For example, FIG. 9 illustrates the composition of images recording the same subject (a user, for example) at the same time by multiple devices, as an example of a composite image generated by the data generator 150. Herein, as described in the third exemplary modification of the present embodiment, audio/video is recorded at the same time by not only the data storage device 1A worn on the user A, but also the respective data storage devices 1 attached to other users or animals, such as the data storage device 1B worn on the user B. Thus, in the case where, a parent and child are each wearing a data storage device 1 on their respective hats, for example, it is possible to acquire recorded images at the height of the parent's point of view as well as recorded images at the height of the child's point of view, and these recorded images may be composited as illustrated in FIG. 9.

Also, although FIGS. 8 to 10 illustrate the case where the stored data is recorded images, the principle is still similar for the case where the stored data is audio recorded data. For example, the playback controller 160 may switch playback audio according to a perspective change operation by the user.

Additionally, the present technology may also be configured as below:

(1) A data storage device that conducts at least one of audio recording and video recording, the data storage device including:

a trigger signal transmitter that transmits a given trigger signal to an external device;

a storage controller that applies control to conduct the at least one of audio recording and video recording; and

a marking unit that marks stored data acquired by the at least one of audio recording and video recording at a time of transmitting the trigger signal.

(2) The data storage device according to (1), wherein the trigger signal instructs the external device to mark stored data acquired by the external device conducting at least one of audio recording and video recording.
(3) The data storage device according to (1) or (2),

wherein the storage controller applies control to continually conduct the at least one of audio recording and video recording, and

wherein the trigger signal transmitter transmits the trigger signal to the external device periodically or non-periodically in a case of continually conducting the at least one of audio recording and video recording.

(4) The data storage device according to any one of (1) to (3), further including:

an instruction unit by which a user arbitrarily issues instructions to acquire stored data by the at least one of audio recording and video recording,

wherein the storage controller applies control to conduct the at least one of audio recording and video recording in response to instructions from the instruction unit, and

wherein the trigger signal transmitter transmits the trigger signal when the instruction unit is operated.

(5) The data storage device according to (4), wherein the instruction unit is one of a shutter button and an audio record button.
(6) The data storage device according to any one of (1) to (5), wherein the data storage device is a wearable device capable of being worn on a user.
(7) The data storage device according to (6), wherein the external device is one of external equipment disposed near the user, and a wearable device being worn on another user.
(8) The data storage device according to any one of (1) to (4), wherein the data storage device is external equipment disposed near a user indoors or outdoors.
(9) The data storage device according to (8), wherein the external device is one of other external equipment disposed near the user, and a wearable device capable of being worn on the user.
(10) The data storage device according to any one of (1) to (9), further including:

a detector that detects a specific command,

wherein the storage controller applies control to conduct the at least one of audio recording and video recording in response to the specific command detected by the detector, and

wherein the trigger signal transmitter transmits the trigger signal to the external device in a case where the detector detects the specific command.

(11) The data storage device according to (10), wherein the detector detects the specific command based on stored data acquired by at least one of audio recording and video recording.
(12) The data storage device according to (10) or (11), wherein the specific command is one of a command instructing audio recording or video recording, and a command indicating an emergency.
(13) The data storage device according to any one of (10) to (12), wherein the detector furthermore generates additional information for conducting at least one of audio recording and video recording.
(14) The data storage device according to (13), wherein the additional information is information indicating a direction of data acquisition by the at least one of audio recording and video recording in response to the specific command.
(15) The data storage device according to any one of (1) to (14), wherein the marking unit marks with time information.
(16) The data storage device according to any one of (1) to (15), further including:

a data generator that generates output data based on first stored data acquired by the data storage device conducting at least one of audio recording and video recording, and second stored data which is marked in a manner that the marking corresponds to a marking of the first stored data and which is acquired by the external device conducting at least one of audio recording and video recording; and

a playback unit that plays back output data generated by the data generator.

(17) A storage medium having a program stored thereon, the program causing a computer to function as:

a trigger signal transmitter that transmits a given trigger signal to an external device;

a storage controller that applies control to conduct at least one of audio recording and video recording; and

a marking unit that marks stored data acquired by the at least one of audio recording and video recording at a time of transmitting the trigger signal.

The present disclosure contains subject matter related to that disclosed in Japanese Priority Patent Application JP 2012-172041 filed in the Japan Patent Office on Aug. 2, 2012, the entire content of which is hereby incorporated by reference.

What is claimed is:

1. A data storage device that conducts at least one of audio recording and video recording, the data storage device comprising:
a trigger signal transmitter that transmits a given trigger signal to an external device;
a storage controller that applies control to conduct the at least one of audio recording and video recording; and
a marking unit that marks stored data acquired by the at least one of audio recording and video recording at a time of transmitting the trigger signal.

2. The data storage device according to claim 1, wherein the trigger signal instructs the external device to mark stored data acquired by the external device conducting at least one of audio recording and video recording.

3. The data storage device according to claim 1,
wherein the storage controller applies control to continually conduct the at least one of audio recording and video recording, and
wherein the trigger signal transmitter transmits the trigger signal to the external device periodically or non-periodically in a case of continually conducting the at least one of audio recording and video recording.

4. The data storage device according to claim 1, further comprising:
an instruction unit by which a user arbitrarily issues instructions to acquire stored data by the at least one of audio recording and video recording,
wherein the storage controller applies control to conduct the at least one of audio recording and video recording in response to instructions from the instruction unit, and
wherein the trigger signal transmitter transmits the trigger signal when the instruction unit is operated.

5. The data storage device according to claim 4, wherein the instruction unit is one of a shutter button and an audio record button.

6. The data storage device according to claim 1, wherein the data storage device is a wearable device capable of being worn on a user.

7. The data storage device according to claim 6, wherein the external device is one of external equipment disposed near the user, and a wearable device being worn on another user.

8. The data storage device according to claim 1, wherein the data storage device is external equipment disposed near a user indoors or outdoors.

9. The data storage device according to claim 8, wherein the external device is one of other external equipment disposed near the user, and a wearable device capable of being worn on the user.

10. The data storage device according to claim 1, further comprising:
a detector that detects a specific command,
wherein the storage controller applies control to conduct the at least one of audio recording and video recording in response to the specific command detected by the detector, and
wherein the trigger signal transmitter transmits the trigger signal to the external device in a case where the detector detects the specific command.

11. The data storage device according to claim 10, wherein the detector detects the specific command based on stored data acquired by at least one of audio recording and video recording.

12. The data storage device according to claim 10, wherein the specific command is one of a command instructing audio recording or video recording, and a command indicating an emergency.

13. The data storage device according to claim 10, wherein the detector furthermore generates additional information for conducting at least one of audio recording and video recording.

14. The data storage device according to claim 13, wherein the additional information is information indicating a direction of data acquisition by the at least one of audio recording and video recording in response to the specific command.

15. The data storage device according to claim 1, wherein the marking unit marks with time information.

16. The data storage device according to claim 1, further comprising:
a data generator that generates output data based on first stored data acquired by the data storage device conducting at least one of audio recording and video recording, and second stored data which is marked in a manner that the marking corresponds to a marking of the first stored data and which is acquired by the external device conducting at least one of audio recording and video recording; and
a playback unit that plays back output data generated by the data generator.

17. A storage medium having a program stored thereon, the program causing a computer to function as:
a trigger signal transmitter that transmits a given trigger signal to an external device;
a storage controller that applies control to conduct at least one of audio recording and video recording; and
a marking unit that marks stored data acquired by the at least one of audio recording and video recording at a time of transmitting the trigger signal.
